(19) United States
(12) Patent Application Publication
(10) Pub. No.: US 2008/0299663 A1
(43) Pub. Date: Dec. 4, 2008

(54) VALIDATION PLATE FOR FLUORESCENCE POLARIZATION MICROPLATE READERS

(76) Inventor: Gordon S. Hudson, Wake Forest, NC (US)

Correspondence Address: MYERS BIGEL SIBLEY & SAJOVEC, PO BOX 37428, RALEIGH, NC, 27627, US

(21) Appl. No.: 11/755,106

(22) Filed: May 30, 2007

(51) Int. Cl. G01N 31/00

(52) U.S. Cl. 436/8

(57) ABSTRACT

A polarization validation microplate for validating fluorescence polarization readers includes a microplate housing and one or more sealed fluorescence polarization samples in the housing positioned for reading by a fluorescence polarization reader.

### FIELD OF THE INVENTION

The present invention relates to validation plates for fluorescence polarization based microplate readers and related methods.

### BACKGROUND OF THE INVENTION

Modern analytical methodologies used by clinical and research laboratories include measuring light absorbance (optical density), light emitted from a chemical reaction (luminescence), light emitted due to an external excitation source (fluorescence), and many others. One emerging technology is fluorescence polarization (FP), which is typically used in receptor binding and in protein or DNA analysis assays.

Fluorescence polarization readers excite fluorescent samples with polarized light of a defined wavelength and measure the emitted light in both a parallel and a perpendicular polarization plane. Large fluorescent molecules, which move comparatively slowly, emit a greater percentage of light in a direction generally parallel to the excitation source. Smaller molecules, which move more rapidly, depolarize the light, which results in about the same amount of fluorescence emitted in both polarization planes. Accordingly, fluorescence polarization readers can provide qualitative information about the size of fluorescent compounds and can be used to differentiate bound and unbound fluorophore homogeneously. In contrast to other techniques, a separation step to remove any unbound fluorophore is typically not required.

The growth of biological research, the development of new pharmaceuticals, and the implementation of novel medical diagnostics have created a need for handling large numbers of test samples. A number of methods are now available for high throughput screening of these samples, for example, for binding events. Fluorescence polarization readers may be used as a screening technique, and association assays such as ligand binding, proteolysis, and DNA cleavage can therefore be measured homogeneously, i.e., generally without “washing” or separation steps. Typically, large numbers of binding assays are processed using fluorescence polarization or anisotropy by placing the assays in multi-well sample plates called microplates. These microplates are typically a rectangular array of open wells, usually 24, 96, or 384 wells in typical examples, but 1536 well and other format microplates may also be used. These microplate wells are filled with test samples and then placed in a fluorescence polarization microplate reader. Fluorescence polarization readers are typically configured to read a polarization value (e.g., measured in “milli-polarization units” or “mP”) from each of the well positions.

Although FP assays can be of great utility in automated screening, there are a number of issues connected with their use that affect their reliability. Linearity of the measurements with respect to fluorophore concentration, and linearity with respect to fluorophore mass (as a function of rotational speed) are particularly important. Fluorescence polarization is generally independent of concentration within the detectable range of the instrument, and therefore, a plot of milli-polarization units (mP) as a function of fluorophore concentration is expected to result in a straight line with a slope of zero. For example, fluorescein, a common fluorophore, has mP of about 30 depending on the temperature and the buffer used. In addition to concentration, the mass of the fluorophore has a proportional influence on the rotational speed, and similarly has a linear, but non-zero, relationship to polarization. The performance of various FP measuring instruments may vary widely, and as the optical and other components of the instrument age, the detection efficiency can be diminished and the measured polarization may lose linearity with respect to both concentration and mass.

### SUMMARY OF THE INVENTION

According to some embodiments of the invention, a polarization validation microplate for validating fluorescence polarization readers includes a microplate housing and one or more sealed fluorescence polarization samples in the housing positioned for reading by a fluorescence polarization reader.

According to further embodiments of the invention, methods for validating fluorescence polarization readers include positioning a validation microplate in the fluorescence polarization reader. The validation microplate includes a microplate housing and one or more sealed fluorescence polarization samples in the housing. A plurality of fluorescence polarization values are measured for the one or more fluorescence polarization samples with the fluorescence polarization reader. The measured fluorescence polarization values for the one or more fluorescence polarization samples are compared with known fluorescence polarization values for the plurality of fluorescence polarization samples.

According to further embodiments of the invention, a validation microplate includes a microplate housing having a base, a cover opposite the base, and a plurality of walls extending between the cover and the base. The cover has a plurality of apertures therein. At least one sample receptacle is between the base and the cover and positioned for reading by a microplate reader at two or more of the plurality of apertures.

In some embodiments, the validation microplate housing is enclosed in packaging.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a top perspective view of a validation microplate according to embodiments of the current invention;

FIG. 2 is a top view of the validation microplate of FIG. 1;

FIG. 3 is an exploded top perspective view of the validation microplate of FIG. 1 showing fluid sample receptacles contained therein;

FIG. 4A is an exploded perspective view of a fluid sample receptacle from the polarization validation microplate of FIG. 1; and

FIG. 4B is a side view of the fluid sample receptacle of FIG. 4A.

### DETAILED DESCRIPTION OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. As used herein, the singular forms a “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, these elements should not be limited by these terms. These terms are only used to distinguish one element from another element. Thus, a “first” element discussed below could also be termed a “second” element without departing from the teachings of the present invention. The sequence of operations (or steps) is not limited to the order presented in the claims or figures unless specifically indicated otherwise.

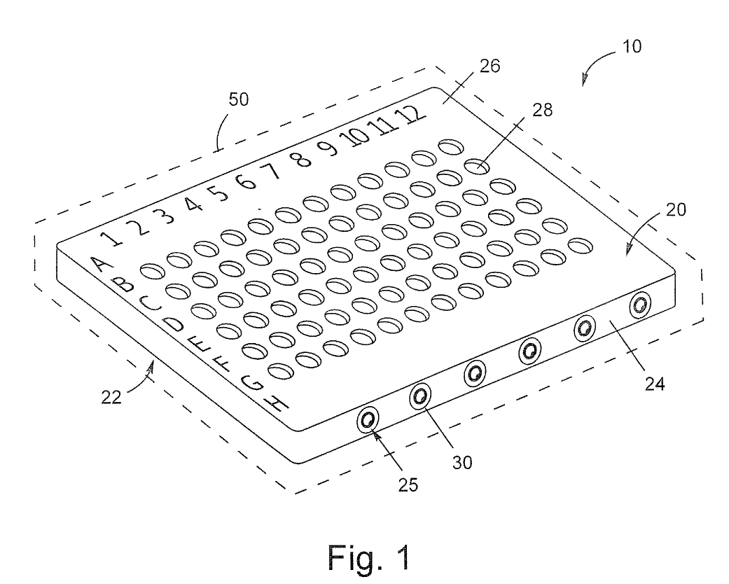

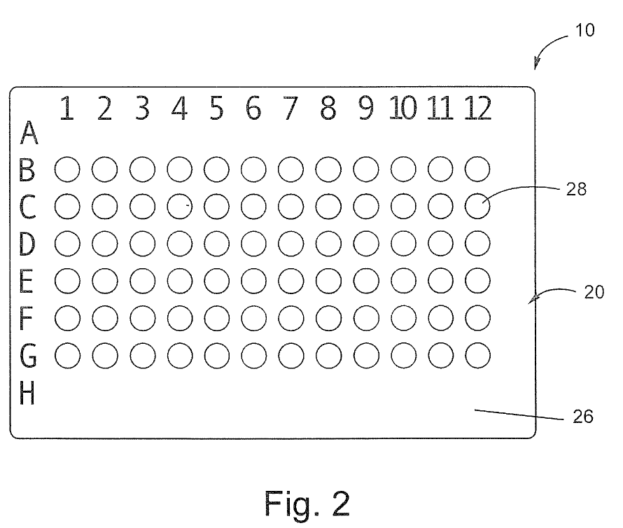

As illustrated in FIGS. 1-3 and FIGS. 4A-4B, a microplate 10 includes a housing 20 and fluid sample receptacles or test tubes 30. The housing 20 includes a base 22 with an opposing cover 26 and a plurality of walls 24 extending therebetween. The walls 24 include sample apertures 25 for receiving the test tubes 30 therein. The cover 26 includes a plurality of apertures 28 that are sized and configured to provide sample measurement locations. A microplate reader (not shown) can measure a sample in one of the test tubes 30 via the apertures 28.

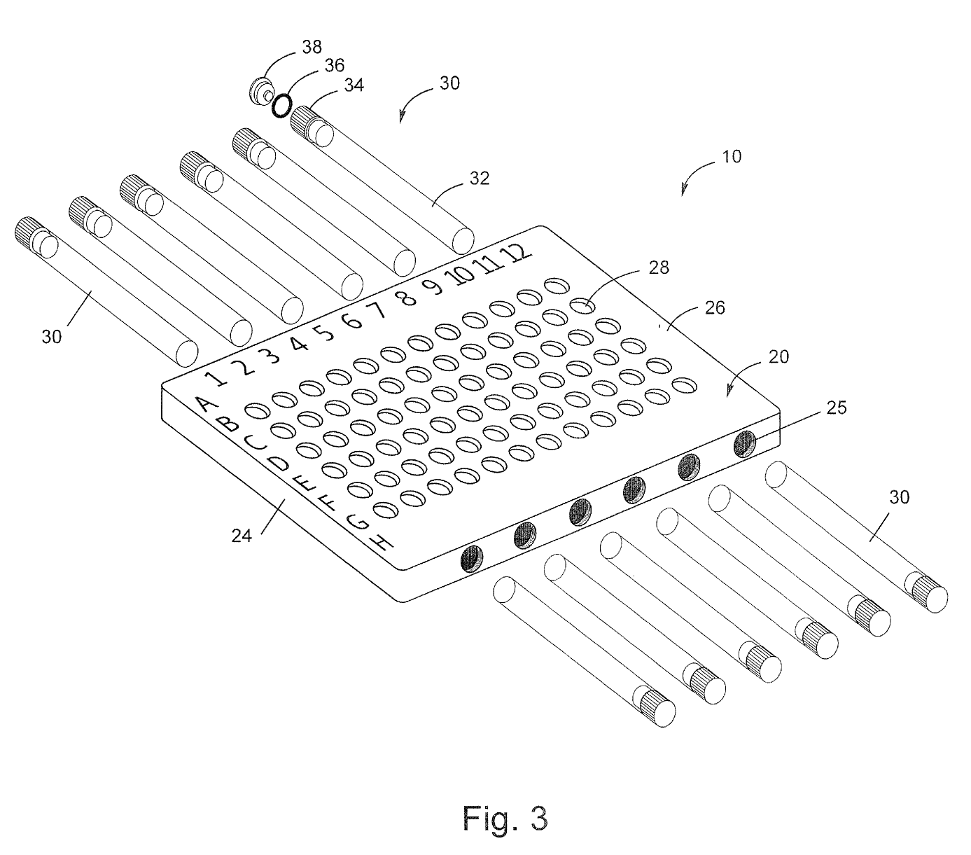

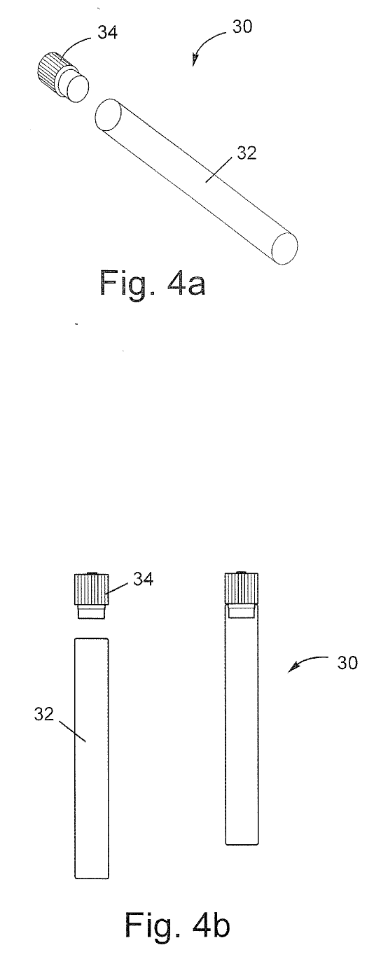

As shown in FIGS. 4A-4B, the test tubes 30 include a tube 32 for containing a fluid sample and a stopper 34. As shown in FIG. 4B, the stopper 34 can provide a fluid seal for sealing the fluid sample in the tube 32 and, consequently, in the housing 20. As shown in FIG. 3, the test tubes 30 can be secured within the housing 20 by a washer 36 and a screw-top or lid 38. As illustrated in FIG. 1, in some embodiments, the microplate 10 and test tubes 30 with a fluid sample therein can be enclosed in packaging 50, for example, for ease of handling and transporting or shipping.

The test tubes 30 are positioned between the base 22 and the cover 26 such that each of the test tubes 30 extends below at least two (and in this case, six) of the apertures 28. In this configuration, a microplate reader can read values from a single sample in one of the test tubes 30 from at least two locations of the apertures 28. Taking multiple readings from the same sample in one of the test tubes 30 may facilitate validation of a microplate reader, e.g., by comparing different readings from the same sample to determine the precision of the microplate reader. For example, the linearity of the microplate reader can be tested with respect to fluorophore concentration, mass, and/or rotational speed. Measured fluorescence values, such as fluorescence polarization values, can be compared with known or pre-determined values to determine the accuracy and/or linearity of the device.

As illustrated, the test tubes 30 are configured to provide a fluid seal to enclose a fluid sample therein. In this configuration, the fluid samples may be pre-mixed in the microplate and may be packaged and/or transported without requiring additional mixing before being used to validate a microplate reader. In some embodiments, the apertures 25 can be a cylindrical hole that is conical or tapered at an end opposite the stopper 34 to facilitate alignment of the test tube 30 within the aperture 25.

In some embodiments, the fluid sample in the test tube 30 includes a fluorescence polarization sample sealed in the housing 20 that is configured to validate a fluorescence polarization reader. For example, at least some of the test tubes 30 can include a fluorescence polarization sample having 1) different fluorescence polarization values, and/or 2) different fluorescence intensities and substantially the same fluorescence polarization value. In some embodiments, a fluorophore, such as fluorescein can be mixed with a fluid, such as water, and/or a buffer, such as borate, and/or an organic solvent, such as alcohol, or a mixture thereof. The samples can be premixed and sealed in the test tubes 30.

For example, the validation microplate 10 can be positioned in a fluorescence polarization reader, and a fluorescence polarization value for the samples in the test tubes 30 may be measured with the fluorescence polarization reader. The measured fluorescence polarization values may be compared with known fluorescence polarization values to validate the polarization reader. In some embodiments, a difference between the measured fluorescence polarization value and the known fluorescence polarization value can be determined and/or the linearity of the reader with respect to fluorophore concentration, mass, and/or rotational speed can be determined. Whether the difference between measured and known fluorescence polarization values is less than a threshold accepted value can also be determined. If the difference between measured and known values is less than the threshold accepted value, the fluorescence polarization reader is generally functioning within accepted parameters. The threshold accepted value can be determined experimentally and/or established by manufacture and/or regulatory agency.

Various techniques may be used to provide fluorescence polarization samples of different polarization values. For example, fluorophores in respective samples can have different masses to provide different polarization values. For example, when the fluorophore is bound to a molecule, the resulting compound is more massive than the unbound fluorophore, which can result in an average reduction in motion of the fluorophore and, consequently, an increased polarization value. Molecules of different masses can be bound to the fluorophore in different samples so that each sample has a different polarization value. In some embodiments, bound or unbound fluorophores of differing masses may be used.

In some embodiments, a fluorophore in a fluid can be mixed with a thickening agent. Without wishing to be bound by theory, the thickening agent can reduce the average movement of the fluorophore, which increases the polarization value of the sample. The samples can include different concentrations of the thickening agent to provide different polarization values. Any suitable thickening agent can be used, such as methylcellulose, propanetriol, or mineral oil.

In some embodiments, at least some of the plurality of fluorescence polarization samples have the same fluorescence polarization value with a different concentration of fluorophore. Fluorescence polarization values are generally independent of concentration. Therefore, fluorescence polarization samples with the same polarization value and a different concentration can be used to test/validate the accuracy of a fluorescence polarization reader and/or to estimate the lowest concentration at which the fluorescence polarization reader is accurate.

In particular embodiments, a filter and/or screen can be used on at least some of the fluorescence polarization samples in the test tubes 30 or at selected apertures 28 to reduce the fluorescence intensity of the sample. Accordingly, filters and/or screens can simulate a reduced concentration in the sample. For example, as illustrated in FIG. 3, the microplate 10 is configured to provide six testing apertures 28 for each test tube 30. The same sample in one of the test tubes 30 can a read by a fluorescence polarization reader at six different testing locations, e.g., to test the accuracy of the readings at different locations of the microplate. However, in some embodiments, a filter and/or screen can be positioned over one or more of the apertures 28 to reduce the fluorescence intensity and simulate a reduced concentration of the sample in the test tube 30 at particular apertures 28. In some embodiments, positioning the microplate 10 at different distances from the microplate reader can simulate a reduction in concentration. Accordingly, a single sample in one of the test tubes 30 can be used to provide polarization values at different intensities and/or to validate a polarization reader at different concentrations/intensities of fluorescence.

Although embodiments according to the present invention are described herein with respect to test tubes 30, it should be understood that other fluid sample receptacle/containers can be used, including cuvettes, tubular containers, or elongated containers with other cross-sectional shapes, such as rectangular cross sections.

Although twelve test tubes 30 are illustrated in FIG. 3, it should be understood that any suitable number of sample receptacle(s) can be used. The sample receptacle(s) can be visible to a fluorescence polarization reader from one or more of the apertures 28. As illustrated, the samples in the test tubes 30 are visible to a fluorescence polarization reader from six aperture positions (i.e., one row of the grid of apertures 28) and corresponding measurements of the polarization values can be read at each aperture 28. In particular embodiments, a single sample receptacle can be used so that a fluorescence polarization reader can read measurements from the sample at different locations (i.e., at different apertures 28) for validation testing with (or without) filters and/or screens to provide different fluorescence intensities at the different apertures 28.

Although it should be understood that any suitable concentration and/or fluorescence polarization value can be used in the sample test tubes 30, in particular embodiments, the fluorescence values of the samples can range from about 30 mP (corresponding to Na fluorescein at room temperatures) to about 400 mP, which is nearly a theoretical maximum value and the sample concentration can range from about 50 pM to 1 μM. In particular embodiments, the National Institute of Standards and Technology (NIST) Standard Reference Material (SRM) 1932, which is a 60.97 μM solution of fluorescein, can be used as a sample material and/or the concentration standards of the samples in the test tubes 30 can be measured concurrently with the SRM, and “NIST equivalent” concentration values may be calculated.

Although the microplate 10 includes six rows of twelve apertures 28 (e.g., 72 apertures), it should be understood that any number of apertures can be used. Common numbers of SBS/ANSI standard microplates include positions for 24, 48, 96, 384, or 1536 apertures. It should also be understood that the apertures 28 define positions for reading a sample with a fluorescence polarization reader and can include a translucent or transparent covering, such as glass or plastic, without departing from the scope of the present invention.

The housing 20 of the microplate 10 can be formed of any suitable material, such as aluminum, brass, or Delrin. It should be understood that the base 22, walls 24 and cover 26 can be formed of separate pieces or as a single, unitary member. In some embodiments, the housing 20 is formed of a single block of material, such as aluminum. In some embodiments, the fluid receptacles (illustrated by test tubes 30) may be integral with the housing 20, for example, so that the fluid receptacle is provided by a sealed or sealable cavity within the housing 20, typically with transparent or translucent apertures 28. The microplate 10 generally has dimensions that are suitable for use in standard fluorescence polarization microplate readers, such as may be defined by the SBS/ANSI standard formats. Examples of fluorescence polarization microplate readers include the Synergy™ from BioTek Instruments, Inc. (Winooski, Vt., U.S.A), the Ultra™, from Tecan Group, Ltd (Switzerland), and the M5™ from MDS Analytical Technologies, Inc. (Sunnyvale, Calif., U.S.A.).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A polarization validation microplate for validating fluorescence polarization readers, the validation microplate comprising:
a microplate housing; and
one or more sealed fluorescence polarization samples in the housing positioned for reading by a fluorescence polarization reader.

2. The polarization validation microplate of claim 1, wherein at least some of the fluorescence polarization samples have different fluorescence polarization values.

3. The polarization validation microplate of claim 1, wherein at least some of the fluorescence polarization samples have different fluorescence intensities and substantially the same fluorescence polarization value.

4. The polarization validation microplate of claim 1, wherein the fluorescence polarization samples comprise a fluid.

5. The polarization validation microplate of claim 1, wherein the fluorescence polarization samples include a fluorophore in a fluid including a thickening agent, at least some of the fluorescence polarization samples having different viscosities.

6. The polarization validation microplate of claim 5 wherein the thickening agent includes at least one of methylcellulose, propanetriol, or mineral oil, and combinations thereof.

7. The polarization validation microplate of claim 1, wherein at least some of the fluorescence polarization samples includes fluorophores of different mass.

8. The polarization validation microplate of claim 7, wherein the fluorophores of different mass include a fluorophore bound to a molecule.

9. The polarization validation microplate of claim 1, further comprising a filter or screen on at least some of the fluorescence polarization samples configured to reduce a fluorescence intensity of a fluorescence polarization sample.

10. The polarization validation microplate of claim 1, wherein the fluorescence polarization samples are sealed in tubular receptacles.

11. The polarization validation microplate of claim 1, further comprising a plurality of apertures in the housing, wherein one or more of the fluorescence polarization samples are positioned for reading by a fluorescence polarization reader at more than one aperture location.

12. The polarization validation microplate of claim 1, further comprising a grid of apertures in the housing, wherein the fluorescence polarization samples occupy one of the rows of the grid.

13. A method for validating fluorescence polarization readers, the method comprising:
positioning a validation microplate in the fluorescence polarization reader, the validation microplate including a microplate housing and one or more sealed fluorescence polarization samples in the housing;
measuring a plurality of fluorescence polarization values for the one or more fluorescence polarization samples with the fluorescence polarization reader; and
comparing the measured fluorescence polarization values for the one or more fluorescence polarization samples with known fluorescence polarization values for the plurality of fluorescence polarization samples.

14. The method of claim 13, wherein at least some of the fluorescence polarization samples have different fluorescence polarization values.

15. The method of claim 13, wherein at least some of the fluorescence polarization samples have different fluorescence polarization intensities and substantially the same fluorescence polarization value.

16. The method of claim 13, wherein the plurality of fluorescence polarization samples comprise a fluid.

17. The method of claim 13, further comprising determining whether a difference between the measured fluorescence polarization values and the known fluorescence polarization values is less than a threshold acceptable value.

18. The method of claim 13, wherein the fluorescence polarization samples include a fluorophore in a fluid including a thickening agent, at least some of the fluorescence polarization samples having different viscosities.

19. The method of claim 18, wherein the thickening agent includes at least one of methylcellulose, propanetriol, or mineral oil.

20. The method of claim 13, wherein at least some of the fluorescence polarization samples includes fluorophores of different mass.

21. The method of claim 20, wherein the fluorophores of different mass include a fluorophore bound to a molecule.

22. The method of claim 13, wherein the microplate includes a filter or screen on at least some of the fluorescence polarization samples configured to reduce a fluorescence intensity of a fluorescence polarization sample.

23. The method of claim 13, wherein the one or more polarization samples are sealed in tubular receptacles.

24. A validation microplate comprising:
a microplate housing having a base, a cover opposite the base, and a plurality of walls extending between the cover and the base, the cover having a plurality of apertures therein; and
at least one sample receptacle between the base and the cover and positioned for reading by a microplate reader at two or more of the plurality of apertures.

25. The validation microplate of claim 24, wherein the sample receptacle includes a fluid sample.

26. The validation microplate of claim 24, wherein the fluid sample comprises a fluorescence polarization sample.

27. A polarization validation microplate assembly for validating fluorescence polarization readers, the validation microplate assembly comprising:
a microplate housing;
one or more sealed fluorescence polarization samples in the housing positioned for reading by a fluorescence polarization reader; and
a packaging enclosure that encloses the microplate housing.
